(19) United States
(12) Patent Application Publication
(10) Pub. No.: US 2017/0081909 A1
(43) Pub. Date: Mar. 23, 2017

(54) Security Panels for Covering Window and Door Openings in Buildings

(71) Applicant: Shield Ups LLC, Dearborn, MI (US)

(72) Inventors: Mousa Ahmad, Dearborn Heights, MI (US); Diana Brehob, Dearborn, MI (US)

(73) Assignee: Shield Ups, LLC, Dearborn, MI (US)

(21) Appl. No.: 15/247,348

(22) Filed: Aug. 25, 2016

Related U.S. Application Data
(60) Provisional application No. 62/222,445, filed on Sep. 23, 2015.

(51) Int. Cl. E06B 9/04; B21D 47/00; E05B 67/00; E05D 7/00; E06B 9/01; E05B 65/00

(52) U.S. Cl. CPC E06B 9/04; E06B 9/01; E05B 65/006; E05B 67/00; E05D 7/009; B21D 47/00; E06B 2009/015

(57) ABSTRACT

A security panel apparatus and a method for covering window and door openings in buildings using the security panel apparatus are disclosed. In one embodiment, the security panel has a main panel, a plurality of sides, and flanges. The flanges have apertures for securing the security panel to the outer surface of the building. Because in practice a service provider is likely to carry multiple panels to a building that needs securing, there is a desire to stow the panels with an efficient use of space in mind both in the warehouse and in the service vehicle. For this reason, the sides form an angle with the main panel that is greater than 90 degrees to facilitate nesting multiple panels.

### FIELD

The present disclosure relates to methods and apparatus for preventing unauthorized access to a building.

### BACKGROUND

When buildings are unoccupied, to prevent unauthorized persons from gaining access to the building through window and door openings, it is known to board up access points, windows and doors, with plywood. However, plywood tends to deteriorate over time as a result of weathering. Furthermore, plywood is relatively easy to breach by a determined vandal.

Some products involve the removal of the window or door and replacing it with a steel covering. The steel covering is affixed to a bar that is inserted through the window opening. However, there are several problems with this approach in some applications. Often in areas in which such security panels are recommended to avoid theft of hot water heaters, furnace, and copper piping, the housing stock is older and the local economy is depressed. In such areas, the windows are older wooden windows that are damaged in the process of removal. Reinstallation is expensive, at the very least. In some cases, particularly with older wood-framed windows, the windows are replaced with new windows as they cannot be refitted into the window reliably. In an economically-depressed area, the cost of replacing even some of the windows outstrips the cost of other alternatives: reinstalling the stolen property, removing the commonly-stolen hardware for safekeeping in a warehouse, or hiring a guard. Additionally, older homes can have non-uniform sizing of windows and frames that are not square, the steel coverings are custom fit or, at the least, custom adjusted for many of the windows. Presently, the purveyors of the steel coverings of this type have a lead time of at least a week. In some applications, that is just too long because opportunist thieves will have already removed the hardware for which there is a black market. An additional problem with the panels fitted in window openings is that the installer needs access to both the interior and exterior of the building.

A security panel 10 disclosed in U.S. Pat. No. 9,091,112 may be placed over the door or window and secured directly to the exterior of the building as shown in FIG. 1. Security panel 10 has a main panel section 11 that has stiffening bends 12 that extend diagonally between the corners of security panel 10 and bend slightly of the plane of security panel 10 toward its forward side, i.e., away from the building when security panel 10 is installed. A plurality of sides (not visible in FIG. 1) extend away from main panel section 10 toward the opening in the building when the security panel is in an installation position. The sides extend normally from main panel section 10. A plurality of flanges 18 each extending away from one of the sides. The side flanges are normal to the sides.

Main panel section 11 has a plurality of small holes 14 for the purposes of ventilation and light transmission. Flanges 18 have holes 20. Fasteners can be put through holes 20 to mount to a building.

In practice, when a building is newly vacant, a service provider is called to the property. The service provider brings multiple panels to install over doors and windows. A problem with the panels disclosed in U.S. Pat. No. 9,091,112, is that they are quite large because they are fitted over the door. So, the outer dimensions of the panels are larger than the largest door for which the panel is designed and include edges that extend even further for the securing holes by which they are affixed to the building. Furthermore, they stand out from the building several inches. Thus, a service provider called to secure multiple homes each with three doors and twelve windows as an example, the space required in the service vehicle is significant to accommodate the security panels. A similar issue occurs in the warehouse. When the security panels are stored in a warehouse, the space occupied by hundreds of such panels is nontrivial.

Another problem with the panels disclosed in U.S. Pat. No. 9,091,112 is that the fasteners are accessible from the exterior of the building. A thief or gang of thieves with a screwdriver can remove the fasteners to take off the security panel to gain access.

### SUMMARY

Security panels that overcome problems in the prior art are disclosed herein.

A security panel for covering an opening in a building that has a central panel section, a plurality of sides extending away from the central panel section toward the opening in the building when the security panel is in an installation position, and a plurality of flanges each extending away from one of the sides in a direction generally parallel. The flanges are coplanar and the sides form an angle with respect to the flanges that is greater than 90 degrees to thereby allow nesting of multiple security panels. The panel may further have a plurality of apertures formed in at least two of the flanges to allow the security panel to be secured to the building over the opening. At least some of the plurality of apertures are configured to allow the security panel to be hung in the installation position from a plurality of locating security head fasteners installed proximate to one or more edges of the opening in the building.

In some embodiments, the main panel has at least two stiffening bends formed therein that intersect. In some embodiments the two stiffening bends form a peak that points inwardly toward the building when in the installation position.

In some applications, the main panel section has a rectangular opening with a door section that is approximately the size of the rectangular opening and a hinge attached between the main panel section proximate a first of the edges of the rectangular opening and a first edge of the door section.

The hinge may be a piano hinge.

In some embodiments, the main panel section has a tab extending outwardly from the building when in the installation position, the tab is proximate a second of the edges of the rectangular opening, the second edge of the rectangular opening is opposite the first edge of the rectangular opening, the door section has a tab extending outwardly from the building when in the installation position, the tab is proximate a second of the edges of the door section, the second edge of the door section is opposite the first edge of the door section, both the tab in the door section and the tab in the main panel have holes defined there, and when the door section is nearly parallel with the main panel section, the holes in the tabs align. A padlock which engages with the holes in the two tabs may be provided.

In some embodiments, security head fasteners extending through the apertures are provided. Heads of the security head fasteners have a nonstandard opening which allow a complementary mating bit to engage with the security head fasteners. The security head fasteners disallow commonly available bits to be used to remove security head fasteners.

Also disclosed is a method for installing a security panel over an opening in a building. A plurality of security head fasteners is placed into the building. A security panel is aligned over the opening in the building. The security panel includes: a central panel section, a plurality of sides extending away from the central panel section toward the opening in the building when the security panel is aligned over the opening in the building, a plurality of flanges each extending away from one of the sides, the flanges being coplanar, a first plurality of apertures defined in the flanges that engage with heads of the security head fasteners, and a second plurality of apertures defined in the flanges that are circular with a diameter allowing a shank of the keyed fastener to pass through and prevents the head of the keyed fastener to pass through. The security panel is hung from the first plurality of security head fasteners.

A first portion of the plurality of the apertures are keyhole shaped to allow the security panel to be hung on the first plurality security head fasteners that are installed into the building prior to placing the security panel in an installation position. A second portion of the apertures are circular. The second portion of apertures accept the second plurality of security head fasteners when the security panel is in the installation position.

The method further includes securing the second plurality of security head fasteners through the second portion of apertures into the building using a mating bit that engages with the security head fasteners.

In some embodiments, the security panel further includes a door section that is approximately the size of the rectangular opening and a hinge attached between the main panel section proximate a first of the edges of the rectangular opening and a first edge of the door section. The main panel section has a tab extending outwardly from the building when in the installation position. The tab is proximate a second of the edges of the rectangular opening. The second edge of the rectangular opening is opposite the first edge of the rectangular opening. The door section has a tab extending outwardly from the building when in the installation position. The tab is proximate a second of the edges of the door section. The second edge of the door section is opposite the first edge of the door section. Both the tab in the door section and the tab in the main panel have holes defined therein. When the door section is nearly parallel with the main panel section, the holes in the tabs align. The method further including: causing the holes in the tabs to align, placing a shackle of a padlock through the holes in the tabs, and locking the padlock.

Also disclosed is a method to manufacture a security panel, that includes cutting a piece of sheet metal to a desired shape, cutting a plurality of apertures into the sheet metal, bending at least two of the edges of the sheet metal to form sides, the sides forming an angle of greater than 90 degrees with a central portion of the security panel to thereby allow nesting of multiple security panels, and bending at least two of the sides to form flanges, the flanges being substantially parallel and lying in the same plane.

The method may also include forming at least two intersecting stiffening bends in the security panel wherein the bends form at least one peak which points inwardly in the same direction that the sides extend from the central portion of the security panel.

The plurality of apertures has a first portion that allows a head of a keyed fastener to pass through and a second portion that allows a shank of the keyed fastener to pass through and prevents the head of the keyed fastener to pass through.

In some embodiments, the desired shape includes an opening in the central portion of the security panel. The method may further include: cutting an ingress opening into the security panel, cutting two slits proximate the ingress opening, bending a tab proximate the ingress opening and the two slits, cutting a door from another piece of sheet metal, bending a tab into the door, installing a first side of a hinge onto the security panel proximate an edge of the ingress opening that is opposite the edge on which the tab is formed, and installing a second side of the hinge onto the door proximate an edge of the door that is opposite the edge on which the tab is formed.

The tab proximate the ingress opening in the security panel and the tab on the door each have an orifice defined therein to accept a shackle of a padlock and the two orifices align when the hinge is fully installed and the door is proximate the ingress opening.

The method may further include forming at least two stiffening bends in the security panel wherein the stiffening bends form a peak and the peak extends inwardly in the same direction that sides extend.

### BRIEF DESCRIPTION OF THE DRAWINGS

FIGS. 1 and 2 are a front view and an end view of a prior art security panel;

FIG. 3 is an end view of a plurality of prior art security panels as may be stowed in a storage facility or in a service truck;

FIG. 4 is an end view of a security panel according to an embodiment of the present disclosure;

FIG. 5 is a side view of the security panel installed onto a building;

FIG. 6 is a front view of the security panel of FIGS. 4 and 5;

FIG. 7 is an end view of a plurality of security panels nested together;

FIG. 8 is a front view of a sheet metal cut out to form a security panel that includes an ingress opening and a door that can be fitted over the ingress opening;

FIG. 9 shows a process by which a security panel is fabricated; and

FIG. 10 shows a process for installing a security panel onto a building.

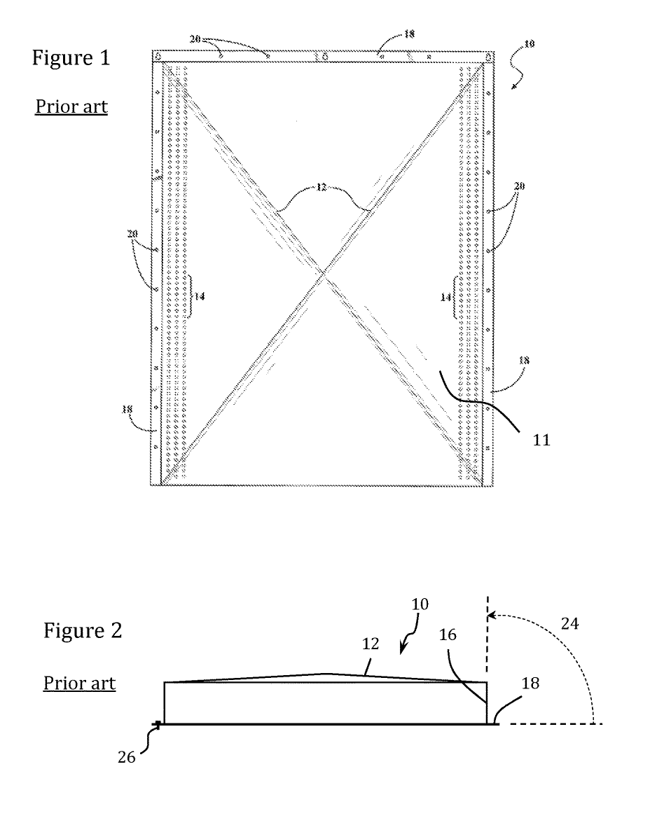

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

In FIG. 4, an end view of a security panel 110 according to an embodiment of the present disclosure is shown. Security panel 110 has sides 116 that are bent with respect to a central portion 111. Flanges 118 are bent from sides 116. The flanges 118 are coplanar (lying in the same plane) so that they sit against the building surface. Sides 116 and flanges 118 form an angle 124 that is greater than 90 degrees. Sides 116 are displaced from perpendicular from flanges 118 by an angle 126. In some embodiments, stiffening bends 112 are formed in central section 111. The peak of bends extends inwardly, i.e., toward flanges 118. A fastener 26 is shown going through an aperture in flange 118.

In FIG. 5, a side view of security panel 110 is shown attached to a building 150. Fasteners 26 go through flanges 118 that sit against the surface of building 150. In FIG. 5, security panel 110 has flanges 118 on the top side and the sides, but not on the bottom edge. Edges 116 are included on the top and bottom edges and edges 116 on the side edges of security panel 110. In some alternative embodiments, there is no edge 116 provided on the bottom side. In other alternatives, there is no flange 118 or edge 116 on the upper side.

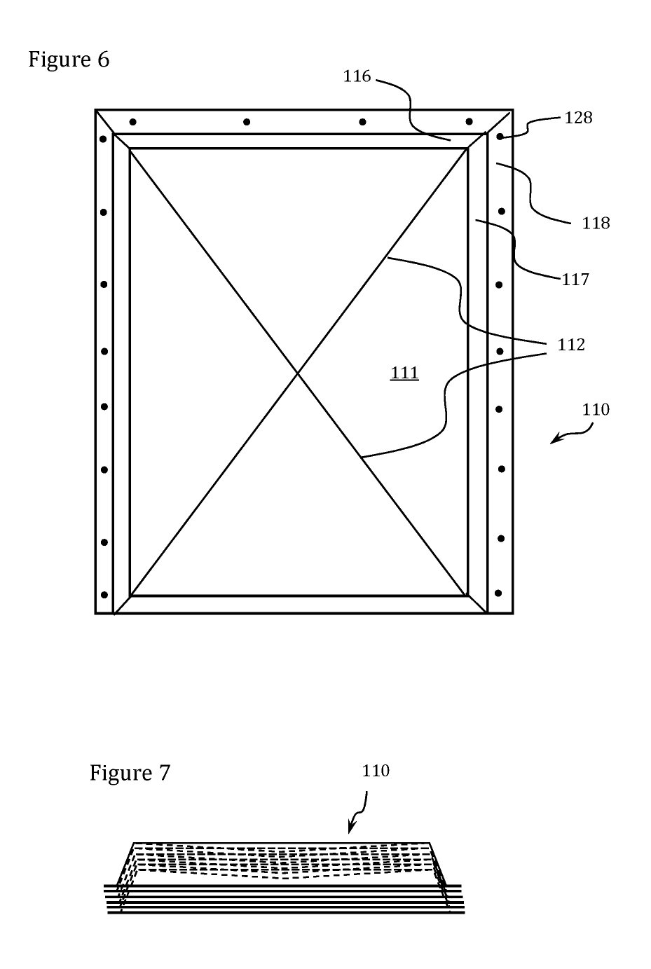

In FIG. 6, security panel 110 has sides 116 and 117 on four edges of security panel 110. Flanges 118 are provided on one of sides 116 and two of sides 117. Flanges 118 each have a plurality of apertures to accept fasteners 26 that secure security panel 110 to building 150. Sides 117 are visible in FIG. 6.

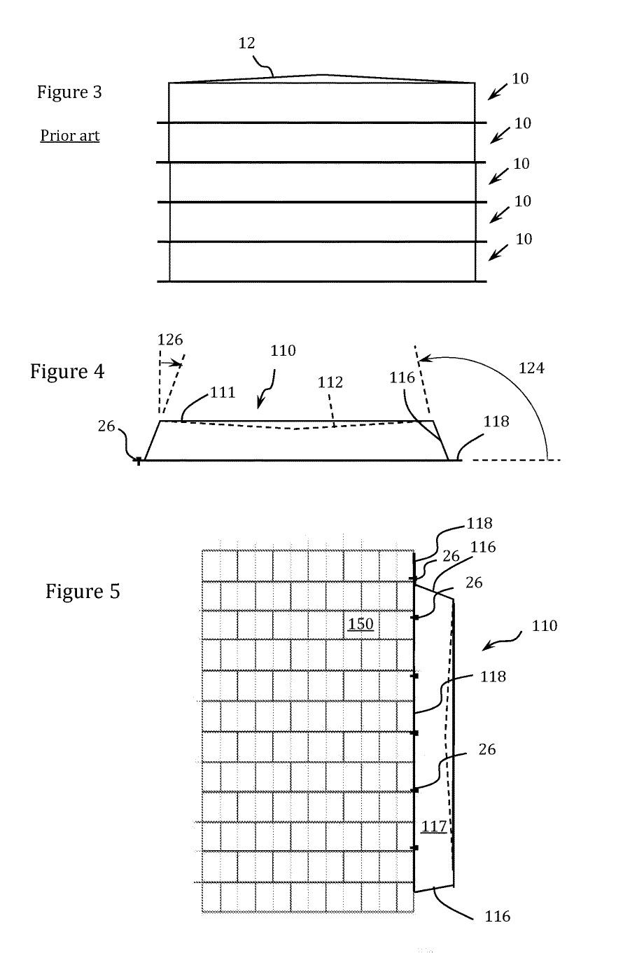

In FIG. 7, six security panels 110 are nested. The space taken up by six panels 110 compares favorably to six prior art panels 10 in FIG. 3.

In some applications, it is desirable to allow ingress to the building by authorized persons. For example, if the building were for sale, it would be desirable to be able to show interested parties the interior of the building.

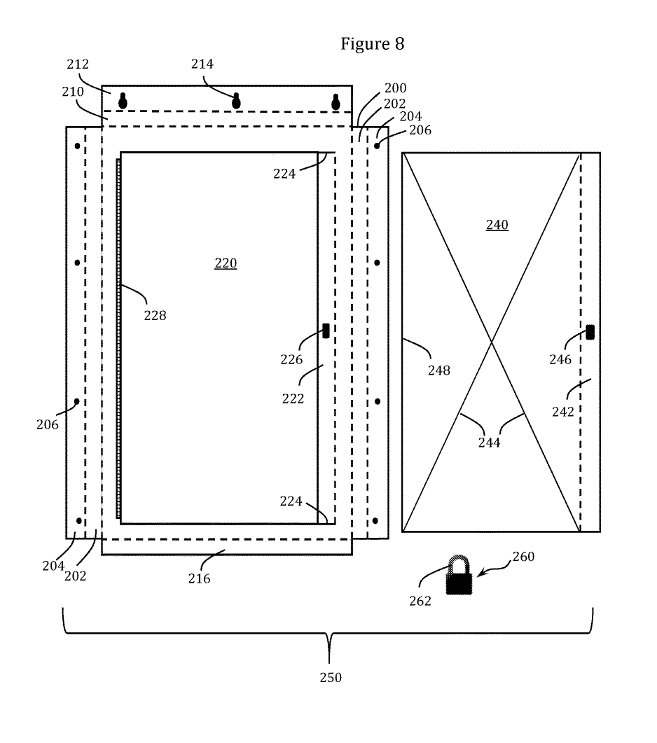

FIG. 8 shows a security panel system 250 that allows such ingress. A security panel 200 is shown prior to bending, i.e., in a flat sheet prior to completing the fabrication of the panel. The exterior edges may be cut via a shears, a laser cutter, a die for stamping, or any suitable tool. The more intricate interior edges may be formed by a laser cutter, a punch, a stamp, or any suitable tool. Sides 202 are shown between two dashed lines, the dashed lines indicating where bends are to be made. Flanges 204 are outboard of edges 202. Flanges 204 have a plurality of apertures 206 that accept fasteners (not shown). An upper side 210 has a flange 212 with keyhole shaped apertures 214. The lower portion of keyhole aperture 214 is large enough for the head of the fastener to go through. Three fasteners can be affixed to the building spaced as apertures 214 are spaced. Apertures 214 are placed over the fasteners. Then, the weight of security panel 200 causes it to drop down so that shanks of the fasteners engage with the upper portion of apertures 214 through which the heads of fasteners cannot travel.

An ingress opening 220 is formed in security panel 200. A tab 222 is formed in security panel 200. It is bent along the dashed line proximate tab 222 and bent outwardly. To facilitate the bending of tab 222, slits 224 are also cut in security panel 224. On the opposite edge of ingress opening 220 from tab 222, a piano hinge 228, or any suitable type hinge is provided. Tab 222 has an opening 226 formed therein. A door 240 is cut from a piece of sheet metal or any suitable material. A tab 242 is formed by bending along the dashed line. An opening 246 is formed in tab 242. In some embodiments, stiffening bends 244 are provided in door 240. To assemble, edge 248 of door 240 is affixed to hinge 228. Door 240 can pivot around hinge 228 to allow access to ingress opening 220. To secure the building, a shackle 262 of a padlock 260 are placed through openings 226 and 246. Then padlock 260 is shut and door 240 remains in a closed position.

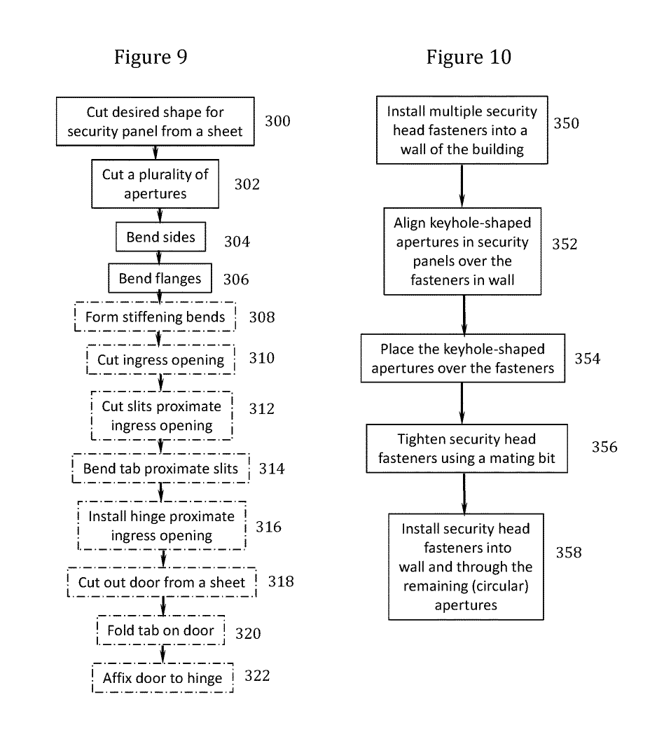

Referring to FIG. 9, a process by which a security panel can be fabricated. In block 300, the outer edges of the security panel are cut from a sheet. In block 302, apertures are defined in the sheet. The apertures may include keyhole shaped apertures and round apertures for securing the panel to a wall; apertures through the panel to allow light and prevent moisture buildup behind the panel; and apertures in a security panel with an ingress door for placing a padlock. The sides are bent in block 304; and the flanges are bent in block 306. Stiffening bends are formed in block 308. As this is an optional part of the process, it is shown with a dash-dot block. Security panels over doors in which there is no need for ingress and for most windows, the fabrication is complete. However, in embodiments in which ingress is desired, the process continues in block 310 in which an ingress opening is cut. The processes in FIG. 9 are described in one non-limiting order and other orders of processes are contemplated by the inventors of the disclosure. For example, block 310, in which an ingress opening is made could be combined with process 300. In block 312, slits are cut proximate the ingress opening which facilitates the bending of a tab proximate the slits in block 314, such tab providing a spot to secure the door edge away from the hinge to the security panel with a padlock, or other suitable securing device. The hinge is installed on an edge of the door opposite the tab in block 316. In block 318, a door is cut out from a sheet, such as from sheet metal. In block 320, a tab is folded in the door. And, the door is affixed to the hinge in block 322.

Referring now to FIG. 10, multiple fasteners are installed into a wall of the building over an opening such as a window or door in block 350. Such fasteners are only partially installed into the wall and arranged in a predetermined alignment that corresponds with the multiple keyhole-shaped apertures of the security panel. Keyhole-shaped apertures in the security panel are aligned over the fasteners in the wall in block 352. The keyhole-shaped apertures are placed onto the fasteners in block 354. The keyed fasteners are tightened using a complementary bit that mates with the security head fasteners in block 356. The fasteners are placed through the remaining apertures and installed into the wall in block 358.

There are a variety of standard bits (tips of screwdrivers or other tools) that are commonly used: flat, Phillips, and hex, to name a few. Because the heads of the fasteners are externally accessible, the security panel could be removed by a diligent vandal. According to one embodiment, custom fasteners, called security head fasteners herein, with a mating bit that are used because they difficult to duplicate and deters opportunist thieves. Such security head fasteners can be ordered from a manufacturer who agrees not to sell your custom bits and fasteners to other customers.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments described herein that are characterized as less desirable than other embodiments or prior art with respect to one or more characteristics are not outside the scope of the disclosure and may be desirable for particular applications.

We claim:

1. A security panel for covering an opening in a building, comprising:
a central panel section;
a plurality of sides extending away from the central panel section toward the opening in the building when the security panel is in an installation position; and
a plurality of flanges each extending away from one of the sides in a direction generally parallel wherein the flanges are coplanar and the sides form an angle with respect to the flanges that is greater than 90 degrees to thereby allow nesting of multiple security panels.

2. The security panel of claim 1, further comprising: a plurality of apertures formed in at least two of the flanges to allow the security panel to be secured to the building over the opening.

3. The security panel of claim 1, wherein at least some of the plurality of apertures are configured to allow the security panel to be hung in the installation position from a plurality of locating security head fasteners installed proximate to one or more edges of the opening in the building.

4. The security panel of claim 1 wherein the main panel has at least two stiffening bends formed therein that intersect.

5. The security panel of claim 1 wherein the main panel has at least two stiffening bends formed therein; and the two stiffening bends form a peak that points inwardly toward the building when in the installation position.

6. The security panel of claim 1 wherein the main panel section has a rectangular opening defined therein, the security panel further comprising:
a door section that is approximately the size of the rectangular opening; and
a hinge attached between the main panel section proximate a first of the edges of the rectangular opening and a first edge of the door section.

7. The security panel of claim 1 wherein the hinge is a piano hinge.

8. The security panel of claim 1 wherein:
the main panel section has a tab extending outwardly from the building when in the installation position;
the tab is proximate a second of the edges of the rectangular opening;
the second edge of the rectangular opening is opposite the first edge of the rectangular opening;
the door section has a tab extending outwardly from the building when in the installation position;
the tab is proximate a second of the edges of the door section;
the second edge of the door section is opposite the first edge of the door section;
both the tab in the door section and the tab in the main panel have holes defined there; and
when the door section is nearly parallel with the main panel section, the holes in the tabs align.

9. The security panel of claim 8, further comprising: a padlock that engages with the holes in the two tabs.

10. The security panel of claim 2, further comprising:
security head fasteners extending through the apertures wherein heads of the security head fasteners have a nonstandard opening allowing a complementary mating bit to engage with the security head fasteners to thereby prevent commonly available bits to be used to remove such security head fasteners when installed onto a building.

11. A method for installing a security panel over an opening in a building, comprising:
installing a plurality of security head fasteners onto the building;
aligning a security panel over the opening in the building, wherein the security panel comprises:
a central panel section;
a plurality of sides extending away from the central panel section toward the opening in the building when the security panel is aligned over the opening in the building;
a plurality of flanges each extending away from one of the sides, the flanges being coplanar, the flanges and sides bent at an angle greater than 90 degrees to facilitate nesting of multiple security panels;
a first plurality of apertures defined in the flanges that engage with heads of the security head fasteners;
and a second plurality of apertures defined in the flanges that are circular with a diameter allowing a shank of the keyed fastener to pass through and prevents the head of the keyed fastener to pass through; and
hanging the security panel from the first plurality of security head fasteners.

12. The method of claim 11, wherein:
a first portion of the plurality of apertures are keyhole shaped to allow the security panel to be hung on the first plurality security head fasteners that are installed into the building prior to placing the security panel in an installation position;
a second portion of the apertures are circular; and
the second portion of apertures accept the second plurality of security head fasteners when the security panel is in the installation position.

13. The method of claim 11, further comprising: securing the second plurality of security head fasteners through the second portion of apertures into the building using a mating bit that engages with the security head fasteners.

14. The method of claim 11 wherein:
the security panel further comprises:
a door section that is approximately the size of the rectangular opening; and
a hinge attached between the main panel section proximate a first of the edges of the rectangular opening and a first edge of the door section wherein:
the main panel section has a tab extending outwardly from the building when in the installation position;
the tab is proximate a second of the edges of the rectangular opening;
the second edge of the rectangular opening is opposite the first edge of the rectangular opening;
the door section has a tab extending outwardly from the building when in the installation position;
the tab is proximate a second of the edges of the door section;
the second edge of the door section is opposite the first edge of the door section;
both the tab in the door section and the tab in the main panel have holes defined therein; and
when the door section is nearly parallel with the main panel section, the holes in the tabs align, the method further comprising:
causing the holes in the tabs to align;
placing a shackle of a padlock through the holes in the tabs; and
locking the padlock.

15. A method to manufacture a security panel, comprising:
cutting a piece of sheet metal to a desired shape;
cutting a plurality of apertures into the sheet metal;
bending at least two of the edges of the sheet metal to form sides, the sides forming an angle of greater than 90 degrees with a central portion of the security panel to thereby allow nesting of multiple security panels; and
bending at least two of the sides to form flanges, the flanges being substantially parallel and lying in the same plane.

16. The method of claim 15, further comprising:
forming at least two intersecting stiffening bends in the security panel wherein the bends form at least one peak which points inwardly in the same direction that the sides extend from the central portion of the security panel.

17. The method of claim 15 wherein the plurality of apertures comprise:
a first portion that allows a head of a keyed fastener to pass therethrough; and
a second portion that allows a shank of the keyed fastener to pass through and prevents the head of the keyed fastener to pass through.

18. The method of claim 15 wherein the desired shape includes an opening in the central portion of the security panel, the method further comprising:
cutting an ingress opening into the security panel;
cutting two slits proximate the ingress opening;
bending a tab proximate the ingress opening and the two slits;
cutting a door from another piece of sheet metal;
bending a tab into the door;
installing a first side of a hinge onto the security panel proximate an edge of the ingress opening that is opposite the edge on which the tab is formed; and
installing a second side of the hinge onto the door proximate an edge of the door that is opposite the edge on which the tab is formed.

19. The method of claim 18 wherein the tab proximate the ingress opening in the security panel and the tab on the door each have an orifice defined therein to accept a shackle of a padlock and the two orifices align when the hinge is fully installed and the door is proximate the ingress opening.

20. The method of claim 15, further comprising:
forming at least two stiffening bends in the security panel wherein the stiffening bends form a peak and the peak extends inwardly in the same direction that sides extend.
